(19) United States
(12) Patent Application Publication
(10) Pub. No.: US 2003/0115154 A1
(43) Pub. Date: Jun. 19, 2003

(54) System and method for facilitating operator authentication

(76) Inventors: Anne H. Anderson, Acton, MA (US); Radia J. Perlman, Acton, MA (US); Stephen R. Hanna, Bedford, MA (US)

Correspondence Address: CESARI AND MCKENNA, LLP, 88 BLACK FALCON AVENUE, BOSTON, MA, 02210, US

(21) Appl. No.: 10/025,596

(22) Filed: Dec. 18, 2001

(51) Int. Cl. H04K 1/00; H04L 9/00; G06F 17/60

(52) U.S. Cl. 705/73

(57) ABSTRACT

A system includes at least one resource, such as a computer, and a high-security authentication device, the at least one resource being selectively utilizable by an operator. The high-security authentication device is configured to perform an authentication operation in connection with a prospective operator and generate a credential for the prospective operator if it authenticates the prospective operator. The at least one resource is configured to, in response to the prospective operator attempting to utilize the resource, initiate an operator authentication verification operation using the credential to attempt to verify the authentication of the operator, and allow the prospective operator to utilize the at least one resource in response to the operator authentication verification operation. Since the system may include a number of such resources, a single, relatively expensive high-security authentication device can be used to provide authentication services for prospective operators for one or more resources. It will be appreciated that, since the high-security authentication device gives the credentials to the prospective operator, they can be compromised; however, since the duration during which the credentials may be valid can be limited to a relatively short period of time, the likelihood of compromise and the duration that the credentials may be comprised are reduced.

### BACKGROUND OF THE INVENTION

1. Field of the Invention

The invention relates generally to the field of digital data processing systems and more particularly to systems and methods for facilitating authentication of prospective operators who wish to make use of computing and other resources provided in such digital data processing systems. The invention particularly provides a system and method that facilitates relatively inexpensive but reasonably secure authentication of prospective users for a number of such resources, such as computers, available in a network.

2. Background Information

In a number of circumstances, it is desirable to be able to authenticate an operator, that is, verify that the operator is who he or she identifies him- or herself as, before allowing him or her to make access to or make use of, for example, a computer, or to access or make use of resources such as web pages, computing resources, applications, information files and other types of resources which will be readily apparent to those skilled in the art. Several methodologies have been developed to facilitate authentication of an operator. In one system, referred to as a password-based authentication system, the operator provides not only his name or other identifier, which may be publicly known, but also a password, which would be known only to the operator and the system whose resource(s) is/are to be used. If the password provided to the system along with an access request matches the password known to the system for the operator identified by the identifier also provided with the access request, then the system would assume that the operator's identity has been authenticated and, if the computer or resource otherwise determines that the operator is authorized to use the requested computer or resource, allow access to the requested resource. On the other hand, if the password does not match the password known to the system for the operator identified by the identifier, the system will assume that the operator's identity has not been authenticated, and may refuse to allow access to the requested resource.

Several problems arise with the use of passwords to authenticate operators. First, in order for passwords to be useful, they need to be secure. However, if an operator does not treat his or her password as secure, that is, if he or she allows others access to his or her password, the security of the password will be compromised. Accordingly, a number of systems require operators to change their passwords frequently. This can create a problem particularly if an operator wishes to access resources on a number of systems, since the operator will need to keep his or her password up-to-date on each of the systems.

To avoid the problem of having to update passwords, authentication arrangements have been developed that issue authentication “certificates” for operators who may wish to access resources in a distributed arrangement. A certificate is issued by a certification authority, which may be affiliated with systems that provide resources that may be accessed, or they may be third-party entities that vouch for the identity of the prospective operators to whom they issue certificates.

For example, in an exemplary certificate-based verification arrangement, the certificate includes operator identification information and a public key, with the corresponding private key being provided to the operator. When the operator wishes to use a system, he or she can provide the certificate to the system. The system, in turn, provides a selected value, such as a random number to the operator, who encrypts the selected value using the private key, and provides the encrypted value to the system. The system uses the public key from the certificate to decrypt the encrypted value. If the decrypted value corresponds to the original value, the system can determine that the operator has possession of the private key for which the public key is in the certificate. If the operator has suitably protected the certificate against modification and the private key against third party access, and if the system trusts the certification authority, the system can determine that the operator identification information is associated with the operator who provided it to the system, thereby authenticating the operator. Since the certificate can be provided to the system when the prospective operator wishes to use it, the operator need not be previously-identified to the system, which would be necessary in, for example, a password-based system. This would alleviate the problems noted above in connection with password-based systems, since the operator need not update password information periodically on all of the systems whose resources may be accessed.

While certificate based systems can be more convenient and secure than password-based systems, they can be compromised if, for example a third party obtains unauthorized access to an operator's private key.

More secure arrangements make use of biometric analysis of prospective operators. Generally, biometric devices are initially used to determine values for a predetermined set of physical characteristics for an operator and associate those values with an identifier for the operator. If a prospective operator wishes to use, for example, a computer, the computer would need to be provided with the previously determined initial values for the prospective operator and a biometric device that is capable of analyzing the prospective operator and determine values for at least some of the same set of characteristics as were previously determined, and provide them to the computer that the prospective operator wishes to use. In addition, the operator will provide his or her identifier to the computer. The computer can then compare the values received from its biometric device to the values determined initially for that operator. If the values compare favorably, the computer will determine that the prospective operator is authenticated, that is, that the person analyzed by the computer's biometric device is the person who is associated with the identifier that he or she provided, and may allow the prospective operator to use it. On the other hand if the values that the computer's biometric device determines for the prospective operator do not compare favorably with the values initially determined for the operator associated with the identifier that the prospective operator provided to the computer, the computer can determine that the prospective operator is not authenticated and may, for example, not allow him or her to use it.

Since arrangements that make use of biometrics to determine whether a prospective operator is authenticated make use of personal characteristics of the prospective operator, they are difficult to fool. But biometrics are not secret, and therefore not obviously useful for network authentication. Biometrics are traditionally used only for authentication to a directly attached computer. Biometric devices are relatively expensive, and providing them at each computer, or even set of computers, would be relatively expensive.

### SUMMARY OF THE INVENTION

The invention provides a new and improved system and method that facilitates relatively inexpensive but reasonably secure authentication of prospective users for a number of resources, such as computers, available in a network.

In brief summary, the invention provides a system including at least one resource, such as a computer, and a high-security authentication device. The high security authentication device is configured to perform an authentication operation in connection with a prospective operator and generate a short-tern credential for the prospective operator if it authenticates the prospective operator. The at least one resource is configured to, in response to the prospective operator attempting to utilize the resource, initiate an operator authentication verification operation using the short-term credential to attempt to verify the authentication of the prospective operator. Depending on other access control policies, as is conventional, the at least one resource can condition allowing the prospective operator to utilize the at least one resource based on the results of the operator authentication verification operation.

The invention provides an arrangement whereby a single, relatively expensive high-security authentication device can be used to provide authentication services for prospective operators for one or more resources. It will be appreciated that, since the high-security authentication device gives the short-term credentials to the prospective operator, they can be compromised; however, since the duration during which the credentials may be valid can be limited to a relatively short period of time, the likelihood of compromise and the duration that the credentials may be comprised are reduced. The time period during which the credentials will be valid can be selected based on any set of criteria, and may be anywhere from a few hours to a few days, weeks or longer based on, for example, the perceived likelihood that the credentials might be compromised over the period during which they will be valid, the damage that might be suffered if the credentials are compromised and other criteria that a system administrator may wish to consider.

### BRIEF DESCRIPTION OF THE DRAWINGS

This invention is pointed out with particularity in the appended claims. The above and further advantages of this invention may be better understood by referring to the following description taken in conjunction with the accompanying drawings, in which:

FIG. 1 is a functional block diagram of a computer network including an arrangement that facilitates the inexpensive but reasonably secure authentication of prospective users for a number of such resources, such as computers, available in the network, in accordance with the invention;

FIG. 2 is a flow chart depicting operations performed by a high-security authentication device included in the computer network in connection with the invention; and

FIG. 3 is a flow chart depicting operations performed by a resource, in particular a computer, included in the computer network in connection with the invention.

### DETAILED DESCRIPTION OF AN ILLUSTRATIVE EMBODIMENT

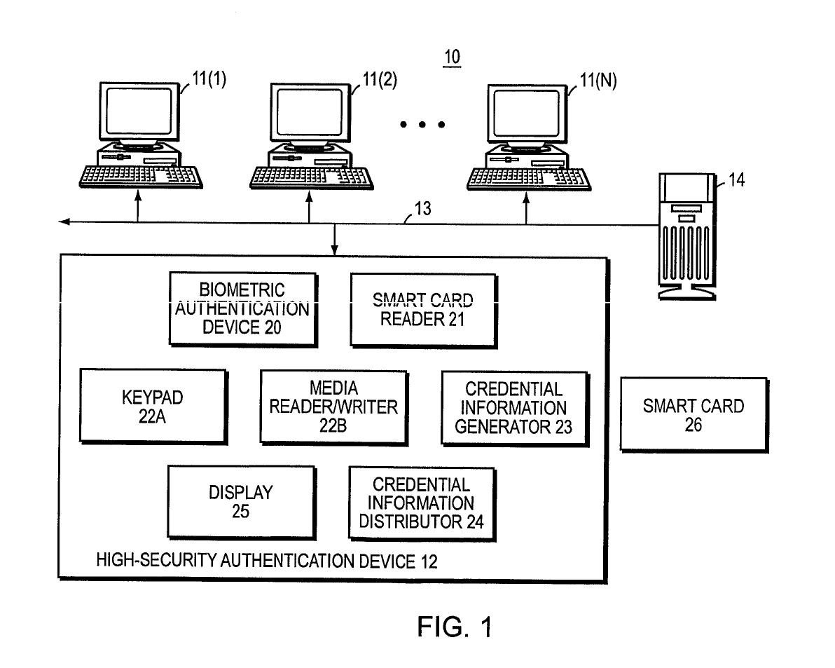

FIG. 1 is a functional block diagram of a computer network 10 including an arrangement that facilitates the inexpensive but reasonably secure authentication of prospective users for a number of resources, such as computers, available in a network, in accordance with the invention. With reference to FIG. 1, the network 10 includes a plurality of computers 11(1) through 11(N) (generally identified by reference number 11(N)) and a high-security authentication device 12 interconnected by a communication link 13. Generally, computers 11(N) can be any type of computer, such as a personal computer or computer workstation, or other device, such as a terminal, through which an operator can log on to and utilize other computers and devices (not shown) that are connected directly thereto or that are accessible over the communication link 13. For example, computers 11(N) may include an embedded computer controlling access to a resource, such as a locked room.

The high-security authentication device 12 can include any type of device that can be used to authenticate a person, including, for example, a biometric authentication device 20, a smart card reader 21 and/or other device that is capable of authenticating a prospective operator who may wish to utilize one or more of the computers 11(N). In addition, the high-security authentication device may include one or more operator input devices such as a keypad 22A and a media reader/writer 22B. The keypad 22A can accept operator input manually provided by the operator. The media reader/writer 22B can read any form of computer-readable medium such as a diskette, tape, bar code or other medium that can carry information in a form that can be read by an appropriate sensing device and, in addition, can store information thereon. The high-security authentication device also includes a credential information generator 23 and a credential information distributor 24, which will be used as described below. The high security authentication device 12 may also include a display 25 for visually displaying information. If a biometric authentication device 20 is provided, the device 20 can acquire biometric information comprising values that are associated with a predetermined set of physical characteristics of the prospective operator, in a conventional manner. If a smart card reader 21 is provided, the smart card reader 21 can utilize credentials that have previously been stored in a smart card 26 that has been issued to the prospective operator. Other types of authentication devices, if provided instead of or in addition to the biometric authentication device 20 and smart card reader 21, will operate in a manner associated with the respective authentication device to authenticate a prospective operator, in a manner that will be apparent to those skilled in the art.

The network 10 includes an arrangement for facilitating the authentication of prospective operators by the computers 11(N), thereby to regulate access to the respective computers. Generally, instead of providing a highly secure authentication each time a prospective operator attempts to log on, which may normally be performed by an apparatus such as the biometric authentication device 20, and which would normally require such a device 20 to be provided at each computer 11(N), in network 10 a prospective operator periodically logs onto the high-security authentication device 12. After the high-security authentication device 12 has authenticated the prospective operator, it generates short-term credentials that may be provided both to the prospective operator and to the computer or computers 11(N) that the prospective operator is authorized to use.

Thereafter, when the prospective operator wishes to utilize one of the computers 11(N), he or she can log onto the computer 11(N) with his or her identifier and also provide his or her short-term credentials to the computer 11(N). The computer 11(N), in turn, can identify the short-term credentials that are associated with the identifier provided by the prospective operator and thereafter perform selected authentication operations, as described below, to attempt to authenticate the prospective operator. If the computer 11(N) determines that the prospective operator is authenticated, and depending on conventional access control policies, it may allow the prospective operator to utilize the computer 11(N). On the other hand, if the computer 11(N) determines that the prospective operator is not authenticated, and also depending on conventional access control policies, it may determine that the prospective operator is not to utilize the computer 11(N). In that case, the computer 11(N) may additionally notify a system administrator of the unauthorized attempt to log onto the computer 11(N).

Since a short-term credential is preferably valid for only a short period of time, illustratively a few hours or days, if an operator wishes to log into a computer after the credential expires he or she will need to be re-authenticated by the high-security authentication device 12, which will issue new short term credentials for him or her in a manner described above. Since only one high-security authentication device 12 is required for the network 10, the cost of the network is reduced in comparison with networks in which one such device is provided for each computer 11(N). However, providing that the credentials that are issued by the high-security authentication device are valid for only a predetermined and relatively short period of time will reduce the likelihood that they might be compromised, and, if they are, reduce the length of time that they would be compromised.

With this background, the arrangement will be described in greater detail in connection with FIGS. 1 through 3. As noted above, initially the prospective operator will use the high-security authentication device 12 to authenticate himself. In that operation, the operator will make use of one or more of the biometric authentication device 20, smart card reader 21 and/or other devices that may be provided by the high-security authentication device 12 to authenticate himself. The biometric authentication device 20, smart card reader 21 or other authentication devices that may be provided are conventional and the operations performed thereby in connection with the authentication will be apparent to those skilled in the art and will depend on the particular type of device or devices used to perform the authentication. During the authentication operation, the biometric authentication device 20, smart card reader 21 and/or other devices(s) that is or are performing the authentication may enable visual indicia indicating the status of the authentication to be provided to the prospective operator by the display 25.

If the biometric authentication device 20, smart card reader 21 and/or other devices(s) that is or are performing the authentication determines that the prospective operator has been authenticated, it or they will so notify the credential information generator 23, along with the identification of the prospective operator. The credential information generator 23 thereafter generates short-term credentials that will subsequently be used by the computers 11(N) to authenticate the operator. The short-term credentials generated by the credential information generator 23 may take any of a number of forms, including one or more of a random number, a personal identification number (“PIN”), a passphrase, a public/private key pair, a ticket-granting ticket, a certificate, or other form that will be apparent to those skilled in the art.

Alternatively, the prospective operator, using the operator input device 22, can choose a passphrase, PIN or other indicia and input it through the keypad 22A for use as the short-term credentials. As another alternative, the operator can provide, for example, a computer readable medium appropriate for the reader/writer 22B on which is encoded any of the types of information described above for use as short-term credentials, which can be read by the reader/writer 22B. Further, the short-term credentials may be an existing credential format or method such as a Kerberos ticket-granting ticket.

After the reader/writer 22B has read the information from the computer readable medium, it can provide the information to the credential information generator 23 for use as the short-term credentials. In any case, the short-term credentials as generated by the credential information generator 24 may also include expiration information, which may include, for example a time stamp indicating the time at which the short-term credentials were generated, in which case the computer or computers 11(N) that receive the short-term credentials may determine an expiration time as being a predetermined time period from the time indicated by the time stamp. Alternatively, the time stamp provided by the credential information generator 24 may indicate the point in time at which they are to expire. As a further alternative, the computers 11(N) that receive the message packets including the credentials can determine the time at which they expire based on the time(s) they were transmitted to the computers 11(N) or the time(s) that they were received by the computers 11(N). As a further alternative, the credential may have an intrinsic time limit, for example, being a function of the time of day.

After the credential information generator 23 has generated the short-term credentials, it provides them, along with the prospective operator's identifier, to the credential information distributor 24 to be distributed to the computers 11(N). The credential information distributor 24 may distribute the short-term credentials to all of the computers 11(N), or, if the operator is only authorized to utilize selected ones of the computers 11(N), to the subset of computers 11(N) that the operator is authenticated to utilize. In that operation, the credential information distributor 24 can package the short-term credentials into message packets that are transmitted over the communication link 13 to various computers 11(N). Preferably, the credential information distributor 24 will transmit the message packets in such a manner that (i) the short-term credentials in the message packets will be secure against third party interception, and (ii) if a third party attempts to transmit message packets containing purported credentials to the computers 11(N), the computer 11(N) will reject them. This secure transmission can be accomplished in several ways. For example, the credential information distributor 24 can establish a secure channel over the communication link 13 with each of the computers over which it transmits the message packets. Alternatively, the credential information distributor 24 can forward the short-term credentials, in a message packet over a single secure channel, to a centralized account management facility 14 that may distribute the short-term credentials to the respective computers 11(N), preferably over secure channels. Other alternatives will be apparent to those skilled in the art.

In addition, if the operator did not provide the credentials him- or herself, the credential information generator 23 provides short-term credentials to the prospective operator. This can be accomplished in a number of ways. For example, the credential information generator 23 can enable the short-term credentials to be printed on paper.

Alternatively, the credential information generator 23 can just enable the display 25 to display the short-term credentials to the prospective operator and require him or her to memorize them. As a further alternative, the credential information generator 23 can provide the short-term credentials in a machine readable form, such as a smart card, floppy disk, magnetic stripe or the like that can be read by an appropriate reader (not separately shown) provided by the respective computers 11(N). It will be appreciated that, if the short-term credentials comprise a random number, passphrase, or PIN, the credential information generator 23 can provide the same credentials to the operator as it gave to the credential information distributor 24.

Alternatively, if the credential is a function of the time at which it was issued, the credential can be verified by the computer 11(N) without any extra communication with the distributor 24.

On the other hand, if the credentials comprise a public key/private key pair, the credential information generator 23 may provide the private key to the potential operator and the public key to the computers 11(N). Alternatively; or in addition, the public key may be provided in a certificate that has been signed by the credential information generator 23 using its public key and provided to the computers 11(N) in a manner similar to that described above. And/or the public key certificate may be provided to the prospective operator on, for example, a suitable computer-readable medium.

After the short-term credentials have been provided to the computers 11(N) and/or prospective operator, if the prospective operator wishes to utilize a computer 11(N) during the period of time for which the credentials are valid, he or she can log onto the computer 11(N) and provide his or her identification and short-term credentials. The computer 11(N), before it allows the prospective operator to use it, will perform an authentication operation determined from the credentials as provided by the operator, the credentials as provided by the high-security authentication device 12, the identification provided by the operator, and/or possibly other information as described below, to determine if the operator is authenticated.

If the computer 11N) determines that the prospective operator has been authenticated, depending on other access control policies, as will be appreciated by those skilled in the art, the computer 11(N) can determine whether the prospective operator is authorized to use the computer 11(N). In connection with the authentication operation, if the credentials are, for example, a random number, passphrase, PIN or the like, the computer 11(N) may need to merely compare the short-term credentials as received from the prospective operator to the credentials as received from the high-security authentication device 12 to determine whether the operator is authenticated.

Alternatively, the computer may compute and verify the short-term credential as a function of some combination of a secret shared with the credential generator, and, for example, the time, the operator's name, a PIN the operator supplies, the computer's identity, etc.

Further, in some cases the computer 11(N) does not need a separate credential from the credential generator to compare to the credential presented by the prospective operator. Cases in which the computer 11(N) does not need a separate credential from the credential generator to compare to the credential presented by the prospective operator comprise:

1. The credential presented by the prospective operator has been signed using the public key of the credential operator, and the public key of the credential operator is possessed by the computer 11(N), or may be obtained in a secure manner.

2. The credential presented by the prospective operator has been encrypted using a secret shared by the credential generator and the computer 11(N).

3. The credential presented by the prospective operator has been encrypted using a secret shared by the computer 11(N) and by a third party that computer 11(N) trusts to authenticate information from the credential generator.

As a further alternative, if the short-term credentials comprise a public key/private key pair, the computer 11(N) may, for example, generate a random number which it provides to the prospective operator. The prospective operator, in turn, can encrypt the random number using his or her private key, and provide the encrypted random number to the computer 11(N). The computer 11(N), in turn, will use the public key to decrypt the is encrypted random number received from the prospective operator and compare the decrypted random number to the random number that had been provided to the prospective operator. If the decrypted random number corresponds to the random number, the computer 11(N) can conclude that the prospective operator is authenticated.

In any case, if the computer 11(N) determines that prospective operator is authenticated, and depending on conventional access control policies, the computer 11(N) may allow the prospective operator to use computer 11(N). On the other hand, if the computer determines that the short-term credentials have expired, or that the prospective operator is not authenticated, and also depending on the access control policies, the computer may determine that the prospective operator is not authorized to use the computer 11(N). If the computer 11(N) determines that the prospective operator is not authorized to use it, computer 11(N) may, for example not allow the prospective operator to utilize it. Alternatively, the computer 11(N) may, for example notify a system administrator, who may determine whether the usage should be allowed and either allow the prospective operator to utilize it, or not, based on the system administrator's determination.

Instead of the high-security authentication device 12 providing the short-term credentials to the computers 11(N), the high-security authentication device 12 or the centralized account management facility 14 may retain them. In that case, when the prospective operator attempts to log onto a computer 11(N), the computer 11(N) can transmit the short-term credentials input by the prospective operator, along with the operator identification value provided by the prospective operator, to the high-security authentication device 12 or centralized account management facility 14, preferably over a secure channel over communication link 13. In that case, the high-security authentication device 12 or centralized account management facility 14 will perform the operations described above as being performed by the computer 11(N) to authenticate the prospective operator. If the high-security authentication device 12 or centralized management facility determines that the prospective operator is authenticated, and if the credentials have not expired, it can transmit a token to the computer 11(N) that, in turn, will enable the computer 11(N) to allow the operator to utilize it.

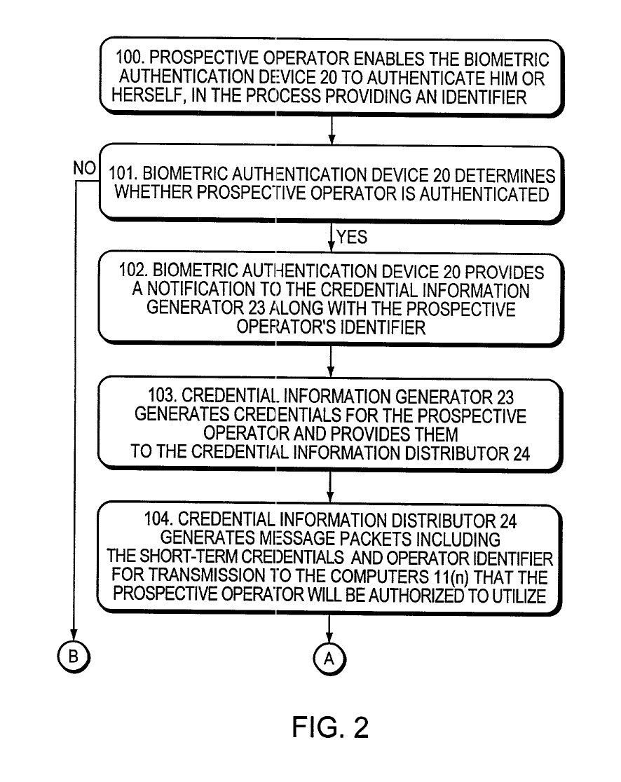

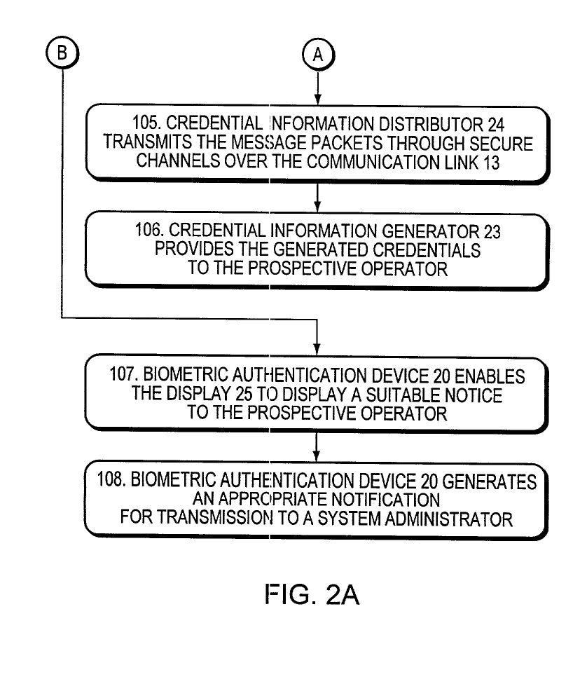

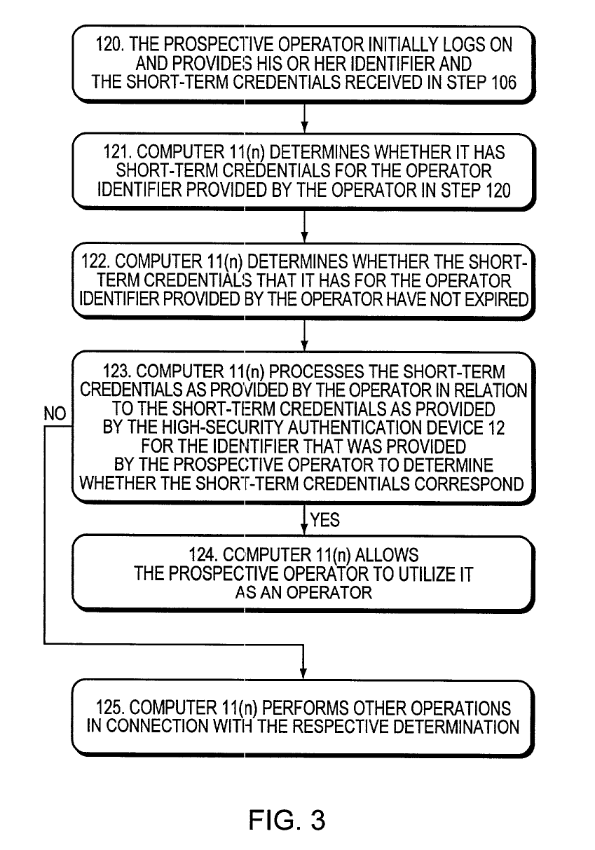

With this background, operations performed by the high-security authentication device 12 and a computer in connection with the invention will be described in connection with flow charts in FIGS. 2 and 3 respectively. In the following, it will be assumed that the high-security authentication device 12 distributes the credentials to the computers 11(N), and that the computers 11(N) perform the operations to authenticate the prospective operator. In addition, it will be assumed that authentication is performed by biometric authentication device 20. Operations performed if authentication is performed by other types of devices will be apparent to those skilled in the art. Accordingly, with reference to FIG. 2, when a prospective operator wishes to obtain short-term credentials for him- or herself, he or she enables the high-security authentication device 12, in particular, the biometric authentication device 20, to initially authenticate him or herself, in the process providing an identifier for the prospective operator (step 100). If the biometric authentication device 20 is successful in authenticating the prospective operator (step 101), it provides a notification to the credential information generator 23 along with the prospective operator's identifier (step 102) to enable the credential information generator 23 to generate the credentials for the prospective operator.

After the credential information generator 23 has generated the short-term credentials for the prospective operator (step 103), it provides the short-term credentials, along with the prospective operator's identifier, to the credential information distributor 24, which generates message packets including the short-term credentials and operator identifier for transmission to the computers 11(N) that the prospective operator will be authorized to utilize (step 104) and transmits the message packets through secure channels over the communication link 13 (step 105).

In addition, the credential information generator 23 provides the generated credentials to the prospective operator (step 106). It will be appreciated that, in performing step 106, the credential information generator 23 may provide the generated credentials in one or more of a number of forms, including paper hardcopy, display to the prospective operator using display 25, recording the credentials onto an appropriate medium using the media reader/writer 22B, and/or any other arrangement for providing the short term credentials to the prospective operator.

Returning to step 101, if the biometric authentication device 20 is unsuccessful in authenticating the prospective operator, it can enable the display 25 to display a suitable notice to the prospective operator (step 107). In addition, it can generate an appropriate notification for transmission to a system administrator (step 108).

As noted above, and with reference to step 103, if the prospective operator provides the short-term credentials him- or herself, in the form of, for example, a passphrase or PIN, he or she can input the passphrase or PIN through the keypad 22A, which the credential information generator 23 can utilize. On the other hand, if the prospective operator provides short term credentials recorded on a computer-readable medium such as a smart card, magnetic strip or the like, the credential information generator 23 can enable the smart card reader 21 to retrieve the credential information from the smart card or the media reader/writer 22B to retrieve the credential information from the computer-readable medium.

As noted above, and with reference to step 105, if, instead of the high-security authentication device 12 providing the short-term credentials to the computers 11(N), it provides them to a centralized account management facility 14, the high security authentication device 12, instead of transmitting the short-term credentials to the computers 11(N), will transmit the short-term credentials to the centralized account management facility 14, preferably over a secure channel over the communication link 13. Thereafter, if the short term credentials are to be provided to the computers, the centralized account management facility 14 can distribute them to the computers 11(N) that the prospective operator is authorized to use.

FIG. 3 is a flow chart depicting operations performed by a computer 11(N) in connection with authenticating a prospective operator. In the following, it will be assumed that the short-term credentials are distributed to the computers 11(N) and that the computers process the distributed short-term credentials and credentials as provided by the prospective operator in authenticating the prospective operator. With reference to FIG. 3, the prospective operator will initially log on, and in that operation will provide his or her identifier and the short term credentials (step 120).

Thereafter, the computer 11(N) will initially determine whether it has short-term credentials for the operator identifier provided by the operator in step 120 (step 121). If the computer 11(N) makes a positive determination in step 121, it will then determine whether the short-term credentials that it has for the operator identifier provided by the operator are still valid, that is, that they have not expired (step 122). If the computer makes a positive determination in step, 122, it will process the short-term credentials as provided by the operator in step 120 in relation to the short-term credentials as provided by the high-security authentication device 12 in step 105 for the identifier that was provided by the prospective operator in step 120, to determine whether the short-term credentials correspond (step 123).

If the computer 11(N) makes a positive determination in step 123, that is, if it determines that the short-term credentials, provided by the prospective operator correspond to the short-term credentials as provided by the high-security authentication device 12, the computer 11(N) can allow the prospective operator to utilize it as an operator (step 124).

Returning to step 121, 122 or 123, if the computer 11(N) makes a negative determination in any of those steps, that is, if it determines in step 121 that it does not have short-term credentials for the operator identifier provided by the operator in step 120, or if it determines in step 122 that the short-term credentials that it does have for the identifier have expired, or if it determines in step 123 that the short-term credentials provided by the prospective operator do not correspond to the short-term credentials as provided by the high-security authentication device 12, the computer 11(N) may not allow the prospective operator to utilize it as an operator (step 125). On the other hand, as noted above, instead of disallowing utilization, the computer 11(N) may interrogate a system administrator as to how to proceed, and may allow or disallow utilization as the system administrator determines.

As described above, and with reference to step 123, the particular operations performed by the computer 11(N) in determining whether the short-term credentials provided by the prospective operator in step 120 correspond to the short-term credentials as provided by the high-security authentication device in step 105 will depend on the nature of the short term credentials.

For example, if the short-term credentials are in the form of a random number, passphrase, or PIN, the computer 11(N) can compare the short term credentials as received from the high security authentication device 12 to the short-term credentials as provided by the prospective operator, and, if they are identical, determine that the two credentials correspond.

On the other hand, if the short-term credentials are in the form of a public key/private key pair, the computer 11(N) can determine that the short-term credentials correspond by the following four steps: generating a random number; transmitting the random number to the prospective operator; having the prospective operator encrypt the number using the private key; and, having the prospective operator transmit the results back to the computer 11(N). The computer 11(N) then decrypts the encrypted value, and compares the original value to the decrypted value. If the original and the decrypted values correspond, the computer 11(N) can determine that the short-term credentials correspond. Methodologies by which the computers 11(N) may determine that the short-term credentials correspond for other types of short-term credentials will be based on the types of short-term credentials, and will be apparent to those skilled in the art.

Operations described above in connection with FIG. 3 assume that the computer 11(N), the computer which the operator wishes to utilize, determines whether short-term credentials exist for the prospective operator (step 121), whether the short-term credentials have expired (step 122), and whether the short-term credentials provided by the prospective operator in step 120 correspond to the short-term credentials as provided by the high-security authentication device in step 105. It will be appreciated that if, for example, the high-security authentication device 12 is to perform these operations, the computer 11(N) can forward the short-term credentials along with the identifier of the prospective operator to the high-security authentication device 12, preferably over a secure channel over communication link 13, which, in turn, can perform the operations described above in connection with steps 121 through 123. The high-security authentication device 12 can return the information to the computer 11(N) indicating the results of the operations. Similarly, if the centralized account management facility 14 is to perform these operations, the computer 11(N) can forward the identifier and credentials that it receives from the prospective operator to the centralized account management facility 14, which will perform corresponding operations.

In addition, in operations described above in connection with FIG. 3, it was assumed that the short-term credentials are distributed to the computers 11(N) and that the computers process the distributed short-term credentials and credentials as provided by the prospective operator in authenticating the prospective operator. It will be appreciated that, if the short-term credentials are provided in, for example, a certificate provided by the operator, the computer 11(N) need only make use of the short-term credentials that are in the certificate, as described above. In this case, the computers 11(N) do not need to be connected via a network.

The invention provides a number of advantages. In particular, the invention provides an arrangement whereby a single, relatively expensive high-security authentication device 12 can be used to provide authentication services for prospective operators for a number of computers 11(N). It will be appreciated that, since the high-security authentication device 12 gives the short-term credentials to the prospective operator, they can be compromised; however, since the credentials are only valid for a relatively limited period of time, the likelihood of compromise and the duration that the credentials may be comprised are reduced. The time period during which the credentials will be valid can be selected based on any set of criteria, and may be anywhere from a few hours to a few days, weeks or longer based on, for example, the perceived likelihood that the credentials might be compromised over the period during which they will be valid, the damage that might be suffered if the credentials are compromised and other criteria that a system administrator may wish to consider.

It will be appreciated that numerous modifications may be made to the arrangement described above. For example, if the high-security authentication device 12 provides a certificate to the prospective operator that has been signed by the high-security authentication device 12, when the prospective operator wishes to log onto a computer 11(N), all the computer 11(N) may need to do is to verify the signature in a conventional manner and, if the signature is verified and the certificate has not expired allow the prospective operator to utilize it.

Furthermore, although the network 10 has been described as comprising computers 11(N) that a prospective operator may wish to utilize, it will be appreciated that the network 10 may include other kinds of resources and devices instead of or in addition to computers that a prospective operator may wish to utilize, which may perform operations similar to those described above in connection with computers 11(N) to determine whether the prospective operator should be allowed to utilize it.

In addition, although the system 10 has been described such that the high-security authentication device 12 distributes short-term credentials to the computers 11(N) for use during an authentication operation, it will be appreciated that, during an authentication operation by a computer 11(N), the computer 11(N) can instead request a copy of the short-term credentials from the high-security authentication device 12 or centralized account management facility 14.

In addition, the high-security authentication device 12, instead of or in addition to authenticating the prospective operator based on his or her identity, can authenticate the prospective operator based on other criteria, such as sobriety, blood pressure, weight, radiation emission, credit worthiness, and/or other personal characteristics of the prospective user. In that case, the high-security authentication device 12 may be provided with such apparatus as a breath analyzer to measure the prospective operator's sobriety, a blood pressure tester to measure the prospective operator's blood pressure, a radiation detector to detect gamma or beta ray emissions, etc. from emission by radioactive material to measure the prospective user's emission of radiation (radioactive emission may be due to either accidental contamination or medical administration, etc.), an arrangement for obtaining information as to the prospective user's credit worthiness, and/or other suitable arrangements for checking other respective personal characteristics. The credit worthiness determination may be made by, for example, a system administrator after interrogating a credit database, or by the high-security authentication device 12 after interrogating the credit database based on criteria provided by a system administrator. Other personal characteristics that might be useful in connection with conditioning usage of the computers 11(N) will be apparent to those skilled in the art, as will arrangements for analyzing those characteristics and determining whether a prospective operator should be allowed to use them.

In addition, where the term authentication has been used, a broader concept where it is determined that a prospective operator has certain attributes can be used. The attributes could be attributes required to access the resources.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

What is claimed is:

1. A system for authenticating an operator, comprising:
at least one resource and a high-security authentication device, the at least one resource being selectively utilizable by an operator;
the high-security authentication device being configured to perform an authentication operation in connection with a prospective operator and generate a credential for the prospective operator if it authenticates the prospective operator; and,
the at least one resource being configured to, in response to the prospective operator attempting to utilize the resource, initiate an operator authentication verification operation using the credential to attempt to verify the authentication of the operator, and allow the prospective operator to utilize the at least one resource in response to the operator authentication verification operation.

2. The system as in claim 1 in which the high-security authentication device further comprises:
a biometric authentication device configured to, during the authentication operation, authenticate the prospective operator in connection with at least one physical characteristic of the prospective operator.

3. The system as in claim 1 in which the high-security authentication device further comprises:
a computer-readable media reader configured to retrieve information from at least one type of computer-readable media and, during the authentication operation, authenticate the prospective operator in connection with authentication information contained on a computer-readable medium provided thereto by the prospective operator.

4. The system as in claim 3 wherein the computer-readable medium further comprises:
a smart card, the smart card having authentication information stored therein, and the computer-readable media reader comprises a smart card reader.

5. The system as in claim 1 wherein the high-security authentication device further comprises:
means for generating credential information for use in the credential.

6. The system as in claim 5 wherein the high-security authentication device further comprises:
means for generating a random number as the credential information.

7. The system as in claim 5 wherein the high-security authentication device further comprises:
means for generating a passphrase as the credential information.

8. The system as in claim 5 wherein the high-security authentication device further comprises:
means for generating a personal identification number (PIN) as the credential information.

9. The system as in claim 5 wherein which the high-security authentication device further comprises:
means for generating a public key/private key pair as the credential information.

10. The system as in claim 5 wherein the high-security authentication device further comprises:
means for generating a ticket-granting ticket as the credential information.

11. The system as in claim 1 wherein the high-security authentication device further comprises:
means for inferring the credential from data supplied by the operator.

12. The system as in claim 1 wherein the high-security authentication device further comprises:
an operator input device configured to receive credential information input thereto by the prospective operator, the high-security authentication device being configured to use the credential information input by the prospective operator in connection with generation of the credential.

13. The system as in claim 1 wherein the high-security authentication device further comprises:
a media reader configured to retrieve certificate information from a machine-readable medium, the high-security authentication device being configured to use the credential information retrieved from the machine-readable medium in connection with generation of the credential.

14. The system as in claim 1 wherein the high-security authentication device further comprises:
means for providing the credential to the prospective operator over a communication link.

15. The system as in claim 1 wherein the high-security authentication device further comprises:
means for providing the credential to the at least one resource over a communication link.

16. The system as in claim 1 wherein the high-security authentication device further comprises:
means for providing the credential to a centralized account management facility.

17. The system as in claim 1 wherein the centralized account management facility further comprises:
means for providing the credential to the at least one resource.

18. The system as in claim 1 further comprising:
means for the at least one resource to receive the credential, the at least one resource being further configured to, when the prospective operator wishes to utilize the at least one resource, perform the operator authentication verification operation in connection with the credential as received to determine whether the credential received corresponds to the credential as provided by the prospective operator.

19. The system as in claim 1 further comprising:
means for the at least one resource to receive the credential from the prospective operator, when the prospective operator wishes to utilize the at least one resource, and transfer the credential to another device, the other device being configured to determine whether the credential as generated by the high-security authentication device corresponds to the credential as provided by the prospective operator, the other device being further configured to notify the at least one resource of the determination.

20. The system as in claim 18 in which the high-security authentication device comprises: the other device.

21. The system as in claim 1 wherein the high-security authentication device further comprises:
means for performing an authentication operation in connection with the identity of the prospective operator.

22. The system as in claim 1 wherein the high-security authentication device further comprises:
means for performing an authentication operation in connection with at least one personal characteristic of the prospective operator other than identity.

23. The system as defined in claim 21 in which the at least one personal characteristic further comprises:
at least one of sobriety, blood pressure, weight, radiation emission, and credit worthiness.

24. The system as in claim 1, wherein the credential further comprises: a short term credential.

25. A method of authenticating an operator, comprising:
operating a system having at least one resource and a high-security authentication device, the at least one resource being selectively utilizable by an operator, the method comprising the steps of:
performing, using a high-security authentication device, an authentication operation in connection with a prospective operator and generating a credential for the prospective operator if it authenticates the prospective operator; and,
in response to the prospective operator attempting to utilize the resource, initiating an operator authentication verification operation using the credential to attempt to verify the authentication of the operator, and conditioning utilization of the resource by the prospective operator in response to the operator authentication verification operation.

26. The method as in claim 24 further comprising:
authenticating the prospective operator in connection with at least one physical characteristic of the prospective operator by a biometric authentication device.

27. The method as in claim 24 further comprising:
retrieving information from a computer-readable media provided by the prospective operator, and during the authentication operation, authenticating the prospective operator in connection with authentication information contained on the computer-readable medium.

28. The method as in claim 26 further comprising:
using as the computer readable media a smart card, the smart card having authentication information stored therein.

29. The method as in claim 24 further comprising:
generating credential information by the high-security authentication device for use in the credential.

30. The method as in claim 24 further comprising:
generating a random number as the credential information.

31. The method as in claim 24 further comprising:
generating a passphrase as the credential information.

32. The method as in claim 24 further comprising:
generating a personal identification number (PIN) as the credential information.

33. The method as in claim 24 further comprising:
inferring the credential from data supplied by the operator.

34. The method as in claim 24 further comprising:
generating a public key/private key pair as the credential information.

35. The method as in claim 24 further comprising:
generating a ticket-granting ticket as the credential information.

36. The method as in claim 24 further comprising:
receiving credential information input into an operator input device by the prospective operator.

37. The method as in claim 24 further comprising:
retrieving certificate information from a machine-readable medium.

38. The method as in claim 24 further comprising:
providing the credential to the prospective operator and to the at least one resource over a communication link.

39. The method as in claim 24 further comprising:
providing the credential to a centralized account management facility.

40. The method as in claim 38 further comprising:
providing, by the centralized account management facility, the credential to the at least one resource.

41. The method as in claim 1 further comprising:
receiving the credential by the at least one resource; and,
configuring the at least one resource to perform the operator authentication verification operation in connection with the credential as received, to determine whether the credential received corresponds to the credential as provided by the prospective operator.

42. The method as in claim 24 further comprising:
receiving the credential from the prospective operator by the at least one resource, when the prospective operator wishes to utilize the at least one resource, and transferring the credential to another device, the other device being configured to determine whether the credential as generated by the high-security authentication device corresponds to the credential as provided by the prospective operator, the other device being further configured to notify the at least one resource of the determination.

43. The method as in claim 41 further comprising:
using the high-security authentication device as the other device.

44. The method as in claim 24 further comprising:
performing an authentication operation in connection with the identity of the prospective operator.

45. The method as in claim 24 further comprising:
performing an authentication operation in connection with at least one personal characteristic of the prospective operator other than identity.

46. The method as in claim 44 further comprising:
using as the at least one personal characteristic at least one of sobriety, blood pressure, weight, radiation emission, and credit worthiness.

47. The method as in claim 24 further comprising: using as the credential a short term credential.

48. A computer readable media comprising:
the computer readable media having information written thereon, the information having instructions for execution in a computer for the practice of the method of claim 24.

49. Electromagnetic signals propagating on a computer network comprising:
said electromagnetic signals carrying information, the information having instructions for execution in a computer for the practice of the method of claim 24.
